(19) United States
(12) Patent Application Publication
(10) Pub. No.: US 2026/0110787 A1
(43) Pub. Date: Apr. 23, 2026

(54) QUARTER-WAVE ROW-COLUMN ARRAY

(71) Applicant: CliniSonix Inc., Edmonton (CA)

(72) Inventors: Roger Zemp, Edmonton (CA); Mohammad Rahim Sobhani, Edmonton (CA)

(21) Appl. No.: 19/327,466

(22) Filed: Sep. 12, 2025

Related U.S. Application Data
(60) Provisional application No. 63/694,744, filed on Sep. 13, 2024.

(51) Int. Cl. G01S 7/521; G01S 15/89

(52) U.S. Cl. CPC G01S 7/521; G01S 15/89

(57) ABSTRACT

An architecture for an edge-addressed ultrasound transducer has an acoustically active layer having a thickness that is substantially one quarter wavelength of a predefined center frequency. The acoustically active layer is bias-voltage sensitive. A backing layer is adjacent to the first surface of the acoustically active layer that has a thickness that is substantially one quarter of a wavelength of the predefined center frequency and an an acoustic impedance that is greater than the acoustically active layer. The backing layer has a plurality of first electrodes in a first electrode layer. A plurality of second electrodes are in a second electrode layer adjacent to the second surface of the acoustically active layer to define a plurality of acoustically active elements within the acoustically active layer.

### FIELD

This relates to ultrasound transducers, and in particular, an edge-addressed ultrasound transducer array.

### BACKGROUND

At present, 3D ultrasound imaging has limited image quality, similar to a cell phone camera with only 32×32 (1024 or 1K) pixels. Going to Mega-Pixel sensors would create a significant advance in 2D and 3D image quality, however, doing so is challenging since, in ultrasound, MHz range signals must be recorded from each element or pixel, and many wires or signal channels are needed which is currently technically infeasible. A 1000×1000 array would require 1 million channels, which would be cost-prohibitive.

To address this challenge, aperture encodable row-column array and novel readout schemes have been proposed, requiring only row- and column addressing. This reduces the required number of channels from N² down to 2N for an N×N array.

Current methods for volumetric imaging include mechanically-swept linear arrays, sparse arrays, matrix arrays and row-column arrays. Mechanically-swept linear arrays generally have poor elevational resolution. Sparse arrays typically exhibit inferior image quality compared to linear arrays but enable ultrafast volumetric imaging. Matrix arrays either use fully-wired elements, with practical limits on size, such as up to 32×32 probes, or use micro-beamformers, which use beamforming approximations and are f-number limited. Microbeamformer-based matrix probes are currently the most advanced technology to date. Row-column arrays require only row- and column addressing but conventional row-column arrays have had limitations of one-way (either transmit or receive but not both) focusing. Additionally, conventional row-column arrays are limited to imaging beneath the shadow of the aperture, significantly limiting volumetric field of view.

### SUMMARY

According to an aspect, there are provided imaging devices, such as arrays and/or probes that allow for a larger number of pixels, and may be implemented to approach Mega-Pixel sensors, which allows for improved image clarity, resolution, and field of view. The imaging devices may be used to track subtle motions and may lead to improved blood flow sensitivity, such as up to 50× compared to current ultrasound technology. The imaging devices may be a row-column array based on electrostrictive materials that may be used to provide improved resolution and frame-rate. The imaging device may use bias voltage encoding, may be used to achieve volumetric sector-scan imaging beyond the shadow of the aperture, and may be used to provide wide ranging transmit and receive focusing throughout an electronically-steerable image plane. The imaging device may be implemented without or with limited in-probe electronics, such that they may be wearable for longitudinal monitoring of the heart or brain, or may be scaled up to larger sizes for other purposes.

According to an aspect, there is provided an architecture for piezoelectric and electrostrictive relaxor ultrasound transducers with addressing from or near the edges of the array. The architecture includes a quarter-wave-thick acoustically active material and a high acoustic impedance quarter-wave dielectric backing layer with air or low-acoustic impedance material as additional structural backing. This architecture enables row-column addressing with the advantage of higher sensitivity, higher bandwidth, and half the needed bias voltages compared to half-wavelength transducers. Additionally, the architecture enables nearly all the acoustic energy to be forward-transmitted, with negligible energy absorbed by the backing, likely enabling less heating when using coded excitation.

According to an aspect there is provided: an architecture for an edge-addressed ultrasound transducer, the transducer architecture comprising
an acoustically-active layer comprised of an acoustically active material or composite material with thickness designed to be substantially close to one quarter of a wavelength of a longitudinal wave along the thickness direction for a particular design center frequency;
one or more top electrodes and one or more bottom electrodes with electrical connections of the transducer being substantially near the edge of the transducer;
one or more front matching layers designed to maximize energy transduction between the acoustically active layer and the transmission medium;
a quarter-wave dielectric backing layer positioned above the top electrodes, the layer having a thickness substantially close to one quarter of a wavelength of a longitudinal wave along the thickness direction of the quarter-wave dielectric backing layer for the particular design center frequency, the acoustic impedance of this backing layer being substantially large compared to the acoustically active layer, the dielectric backing comprising Sapphire, diamond or other high-impedance dielectric;
the quarter-wave dielectric backing layer adhered to the top side of the acoustically active layer and top electrodes using a thin layer of adhesive, the thickness of the adhesive being substantially less than a quarter of a wavelength of the particular design center frequency;
a low acoustic impedance material positioned above the quarter-wave dielectric backing layer, the acoustic impedance being substantially less than the acoustic impedance of the acoustically active layer

According to other aspects, the architecture may include one or more of the following features:
the quarter-wave backing layer comprising a substantially optically-transparent or translucent material;
the quarter-wave backing layer comprised of sapphire, Diamond, a ceramic, or transparent aluminum
the acoustically active layer comprised of a piezoelectric single crystal substrate, a piezoelectric ceramic, or electrostrictive relaxor material, or a composite including these material;
the acoustically active layer comprising PMN-PT;
the acoustically active layer comprising a 1-3 composite the top and/or bottom electrodes patterned to form a row-column array, a synthetic phase alternating row-column array, a Costas array, a sparse array, or other edge-addressed array
the acoustically active layer comprising an electrostrictive relaxor material and external electronics used to supply bias voltages to cause the electrostrictive relaxor to become effectively piezoelectric
the top and bottom electrode comprised of a transparent conductor such as Indium Tin Oxide
transparency of the conductive layer enhanced with silver nanowires, a thin layer of silver, or thin metal electrodes which do not overly obscure overall optical transparency.

According to an aspect, there is provided a method for manufacturing an edge-addressed ultrasound array, the method comprising:
lapping an acoustically active material or composite material to planarize the top surface, the bottom surface adhered to a substantially flat carrier;
depositing a conductor on the top side of the acoustically active material or composite material;
patterning the conductive layer to form electrodes;
releasing the acoustically active material or composite material from the carrier and flipping it to then adhere the formerly top surface to an additional substantially flat carrier;
lapping the acoustically active material or composite material to a desired thickness, the desired thickness being substantially close to a quarter of a wavelength of a design center frequency
depositing a conductive layer on the new top side the acoustically active material or composite material;
patterning the conductive layer on the new top side to form electrodes;
adhering a rigid and substantially flat dielectric backing layer to the acoustically active material or composite material and top electrodes, the backing layer comprised of a material with an acoustic impedance which is large compared to the acoustically active material or composite material, the backing layer being of a thickness which is substantially close to one quarter of a wavelength of the design frequency; the thickness of the adhesive layer substantially less than a quarter of the wavelength of the design center frequency;
connecting the top and bottom electrodes to a printed circuit board or flexible printed circuit board or other electrical interconnects from the edges of the array;
forming one or more matching layers on the active aperture of the array, the one or more matching layers being designed to maximize energy transduction between the acoustically active layer and the transmission medium

According to other aspects, the method may include one or more of the following features:
the additional substantially flat carrier comprising a printed circuit board or rigid-flexible printed circuit board;
the electrodes patterned using a laser micromachining system, a photolithography system, or using a dicing saw;
the electrical interconnects formed using wire-bonding, laser micromachining of deposited conductors, soldering, or laser sintering;
the quarter-wave backing layer comprising a substantially optically-transparent or translucent material;
the quarter-wave backing layer comprised of sapphire, Diamond, a ceramic, or transparent aluminum;
the acoustically active layer comprised of a piezoelectric single crystal substrate, a piezoelectric ceramic, or electrostrictive relaxor material;
the acoustically active layer comprising PMN-PT;
the acoustically active layer comprising a 1-3 composite;
the top and/or bottom electrodes patterned to form a row-column array, a synthetic phase alternating row-column array, a Costas array, a sparse array, or other edge-addressed array;
the acoustically active layer comprising an electrostrictive relaxor material and external electronics used to supply bias voltages to cause the electrostrictive relaxor to become effectively piezoelectric

According to an aspect, there is provided a method for imaging, the method comprising:
delivery of acoustic or electromagnetic energy to a target, and comprising reception of ultrasonic energy, the ultrasonic energy transduced to electrical energy using an edge-addressed transducer;
the edge-addressed transducer comprising:
   an acoustically-active layer comprised of an acoustically active material or composite material with thickness designed to be substantially close to one quarter of a wavelength of a longitudinal wave along the thickness direction for a particular design center frequency;
   one or more top electrodes and one or more bottom electrodes with electrical connections off the transducer being substantially near the edge of the transducer;
   one or more front matching layers designed to maximize energy transduction between the acoustically active layer and the transmission medium;
   a quarter-wave dielectric backing layer positioned above the top electrodes, the layer having a thickness substantially close to one quarter of a wavelength of a longitudinal wave along the thickness direction of the quarter-wave dielectric backing layer for the particular design center frequency, the acoustic impedance of this backing layer being substantially large compared to the acoustically active layer;
   the quarter-wave dielectric backing layer adhered to the top side of the acoustically active layer and top electrodes using a thin layer of adhesive, the thickness of the adhesive being substantially less than a quarter of a wavelength of the particular design center frequency;
   a low acoustic impedance material positioned above the quarter-wave dielectric backing layer, the acoustic impedance being substantially less than the acoustic impedance of the acoustically active layer; and
   the received signals from the edge-address ultrasound transducer digitized and processed using a processor to form images.

According to other aspects, the method may include one or more of the following features:
the electromagnetic energy source comprising light from an optical source;
a portion of the electromagnetic energy delivered through the array;
the quarter-wave backing layer comprising a substantially optically-transparent or translucent material;
the quarter-wave backing layer comprised of sapphire, Diamond, a ceramic, or transparent aluminum;
the acoustically active layer comprised of a piezoelectric single crystal substrate, a piezoelectric ceramic, or electrostrictive relaxor material;
the acoustically active layer comprising PMN-PT;
the acoustically active layer comprising a 1-3 composite;
the top and/or bottom electrodes patterned to form a row-column array, a synthetic phase alternating row-column array, a Costas array, a sparse array, or other edge-addressed array; and
the acoustically active layer comprising an electrostrictive relaxor material and external electronics used to supply bias voltages to cause the electrostrictive relaxor to become effectively piezoelectric.

Other aspects will be apparent from the description and claims.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1A is a side elevation view in section of a prior art transducer architecture.

FIG. 1B is a side elevation view in section of an alternative transducer architecture.

FIG. 1C is a side elevation view in section of a transducer architecture connected to a PCB.

FIG. 2A-2F depict a series of step use to manufacture a transducer architecture.

FIG. 3 is a graph comparing a pulse-echo response of a transducer architecture with an epoxy-sapphire backing layer and a conventional alumina-epoxy backing layer.

FIG. 4 is a graph comparing a pulse-echo spectrum of a transducer architecture with a ¼ wavelength, epoxy-sapphire backing layer and a ½ wavelength, alumina-epoxy backing layer.

FIG. 5 is a photo of an edge-addressed transducer architecture.

FIG. 6 is a photo showing details of an edge-addressed transducer architecture.

### DESCRIPTION OF PREFERRED EMBODIMENTS

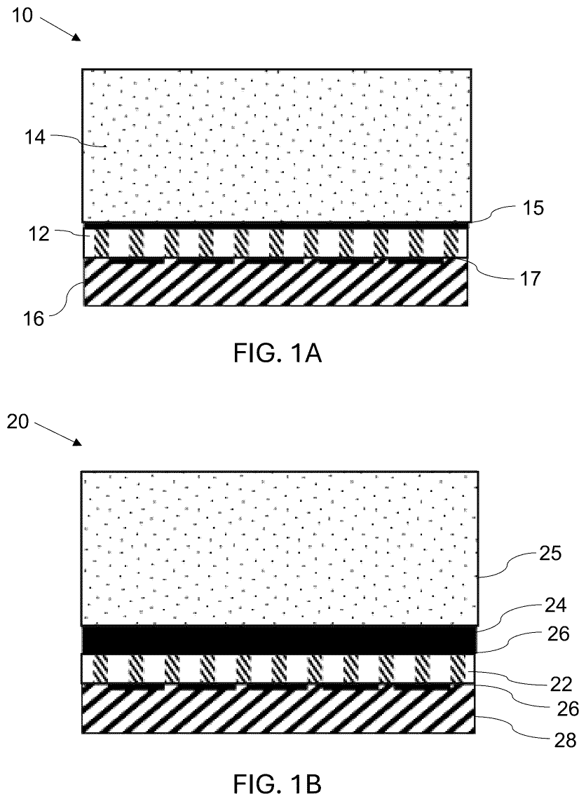

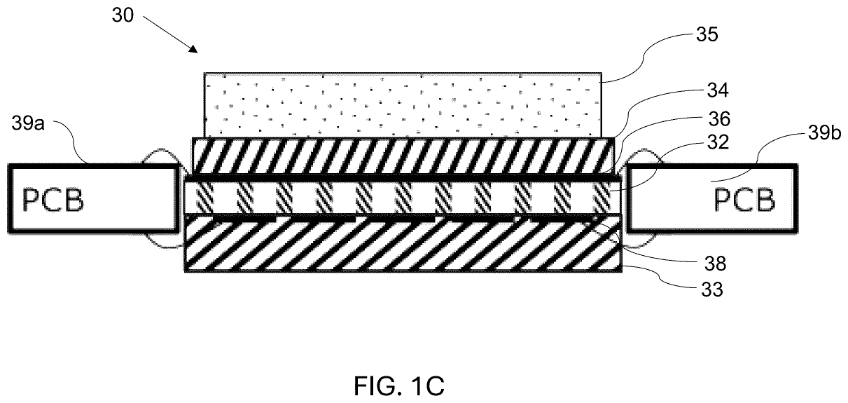

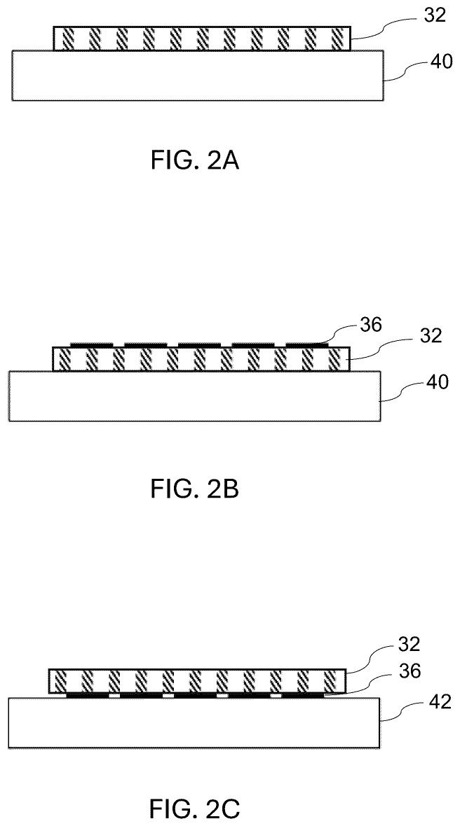

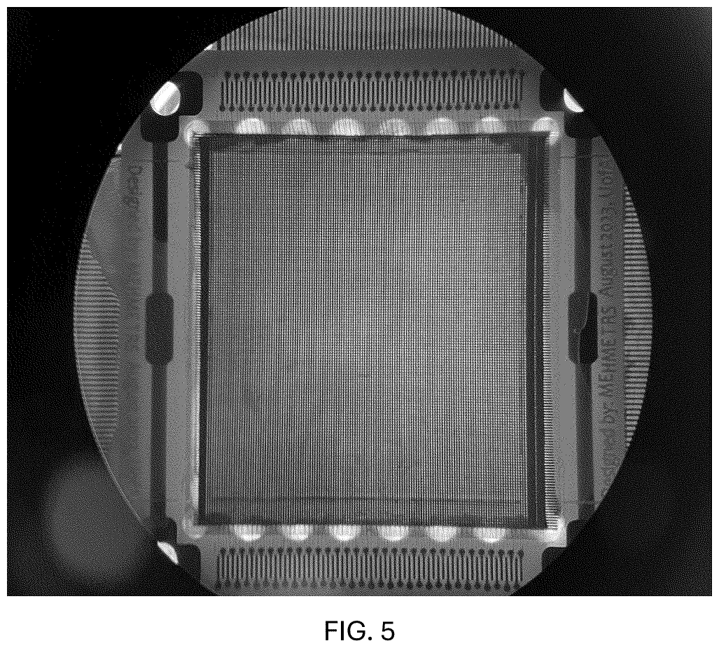

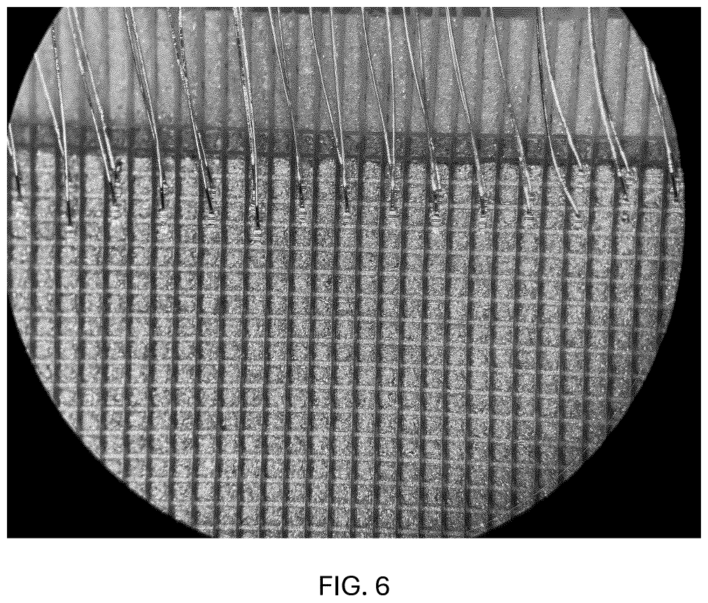

Referring to FIG. 1A, there is shown an example of a transducer architecture 10, having a piezoelectric or electrostrictive transducer layer 12 designed with half-wavelength thickness positioned between an attenuating backing layer 14 made from a suitable material such as an alumina-epoxy, a matching layer 16, and first and second electrode layers 15 and 17. Transducer layer 12 may have a row-column array, similar to the array depicted in FIGS. 5 and 6. Referring to FIG. 1B, an alternative transducer architecture 20 is shown having a piezoelectric or electrostrictive transducer layer 22 with a quarter-wavelength thickness and a quarter-wave backing layer 24, such as a high-impedance, rigid, and high-sound-speed backing layer and a first conductive layer 26 that defines a first set of electrodes. Transducer layer 22 may be an acoustically active material such as an electrostrictive relaxor material that, in operation, operates as a piezoelectric material when a bias voltage is applied. An example of a suitable material for backing layer 24 is a C-Plane sapphire. There may be an additional backing layer 25. Other examples of suitable materials are discussed below. Transducer architecture 20 also includes a second conductive layer 28 that defines a second set of electrodes positioned at an angle relative to first set of electrodes in first conductive layer 26 to define an array of acoustically active elements in transducer layer 22. Transducer architecture 20 may also include a matching layer 28 that is used to facilitate the energy transduction between acoustically active layer 22 and the medium into which the energy is to be transmitted.

Referring now to FIG. 1C, a transducer architecture 30 is shown that may be used to enable top-orthogonal to bottom and other edge-addressed architectures, where electrode patterning on the top and bottom of the composite is possible, and where shorting or parasitic capacitance between top electrodes is minimized. Transducer architecture 30 has a transducer layer 32, a dielectric backing layer 34, a further backing layer 35, a first conductive layer 36 that forms top electrodes, a second conductive layer 38 that forms bottom electrodes, and a matching layer 33. Top and bottom electrodes may be made of transparent conductors to achieve optical transparency. First and second conductive layers 36 and 38 may be wire-bonded to PCBs 39a and 39b, in order to voltage-bias the array. Other suitable control elements may also be used.

Referring to FIG. 1B, backing layer 24 may be tungsten. One limitation of the tungsten or tungsten-carbide backing is that it is conductive, and may lead to shorted back-side electrodes or introduce unwanted parasitic capacitance if a thin insulating layer is used. When the backside of the array requires patterned electrodes, as in a row-column array or otherwise edge-addressed array, the backing layer should ideally be non-conducting. Backing layer 24 may therefore be a dielectric such as sapphire, with properties including high acoustic impedance, high sound-speed (important to enable a thick layer even when the layer thickness is specified to be a quarter-wave thickness), and high optical transparency (to enable transparent variants of arrays). An overall proposed architecture is shown in FIG. 1C.

There will now be considered calculations for quarter-wave-thick transducers with quarter-wave-back matching layers using sapphire. Sapphire is insulating and transparent and has a high acoustic impedance. Sapphire has a very high sound speed which means we can use thick plates as quarter-wave high-Z back-matching layers, thick enough to support air backing without any additional supporting epoxy layer (air would be the ideal backing as it would maximize the effective back-impedance). At the center frequency, the effective acoustic impedance looking from the transducer into the backing is:

$${Z}_{eff} = \frac{{Z}_{Q W L}^{2}}{{Z}_{B}}$$

where Z_{QWL} is the acoustic impedance of the quarter-wave backing layer and Z_{B} is the acoustic impedance of the additional backing layer (here targeted to be simply air).

If needed, epoxy may still be used for backing. In either case, this design may be used for transparent or opaque TOBE arrays with half the thickness of current designs (which would lower the bias voltage requirements, leading to faster switching, lower costs and safer designs), and with improved sensitivity (energy loss is minimized as it is all forward-coupled) and improved bandwidth, thus providing better axial resolution.

Some example calculations are given below:
Acoustic impedance of C-plane sapphire: 39.60 MRayl
Targeted Center Frequency: 3.13 MHz
Sapphire thickness: 0.90 mm
Backing Material: Air

### Resulting Calculations:

Effective Impedance of sapphire quarter-wave layer=39600000.00 MRayl
Reflection Coefficient: 0.999999

With epoxy as the backing layer on top of the quarter-wave layer, and for the same center frequency:
Effective Impedance of sapphire quarter-wave layer=522.72 MRayl
Reflection Coefficient: 0.937004

As can be seen, in either case, almost all the energy is forward-transmitted and almost nothing goes into the backing layer.

This may be compared to using glass as a quarter-wave backing layer, where the acoustic impedance of glass is ˜10MRayl. In this case, epoxy as an additional backing layer may also needed:
Effective Impedance of sapphire quarter-wave layer=33.33 MRayl
Reflection Coefficient: 0.324503

This is much less effective than a sapphire quarter-wave back matching layer.

High-sound-speed sapphire may also result in ultrathin backing layers, resulting in thin arrays for wearable applications. Sapphire is also very stiff, with a Young's modulus of 345 GPa. The fracture toughness of C-plane sapphire is about 4.24 MPa·m^{1/2} compared with 0.6-0.8 for glass. It is also relatively hard −9 on the Mohs scale. Glass is 5.5-6 on the Mohs scale. Thus, a thin layer of sapphire (with no additional backing) will be tough, will not permit unwanted flexure, and should not break easily.

Sapphire is widely available in wafer form. Diamond may also be used, however diamond is much more expensive, less available, and more difficult to work with. Another advantage of sapphire is that one should be able to inspect bonding to the PMN because it is transparent. If there are bond-voids, one could re-do the bonding. Also, traditional epoxy-loaded backings are opaque, and any issue on the buried connection wires wouldn't be noticeable, impacting the overall performance of the TOBE arrays. With the transparent sapphire backing, the inspections may be performed after the fabrication to ensure the connection gold wires on the back side of the array are in their position.

One potential advantage of the proposed transducer architecture is that using a backing layer that is less absorbing may lead to improved thermal management for using coded excitation. Much of the heating with coded excitation in other devices is likely absorption by the backing material, with no thermal dissipation mechanism. With the proposed architecture, not is it possible to implement with a less absorbing backing material, but also >99% of the energy is forward-transmitted, as a result of a backing layer that has a quarter wavelength thickness and a high impedance. Thus, the new architecture should enable coded excitation, allowing for deeper penetration, higher operating frequencies, and thus better resolution.

Also, for the same ultrasound platform, the proposed quarter-wavelength-thick transducer may generate more acoustic energy than the conventional half-wavelength-thick transducer for the same excitation pulses, as the effective induced electric field would be greater. This may increase the penetration for higher frequency arrays, thus offering micro-ultrasound resolution and clinical depths.

Another benefit of the proposed quarter-wavelength-thick transducer may be less chipping during the dice and filling step for making 1-3 composite arrays where the cutting blade would be required to penetrate only half of the thickness compared to conventional methods.

For this architecture, the PMN material itself could heat up if operated in air. This may be mitigated by having the transducer fluid-coupled (like with a latex bag of water attached) or a sensor or program that detects whether there is fluid coupling or not. This may be detected by some kind of impedance sensing. The electrical impedance may change based on air/fluid coupling.

This architecture may be used with various types of arrays, such as TOBE, SPARC, and TOBE-Costas/SPARC-Costas Arrays, and may be used as a platform for large-scale arrays.

### Manufacturing Process:

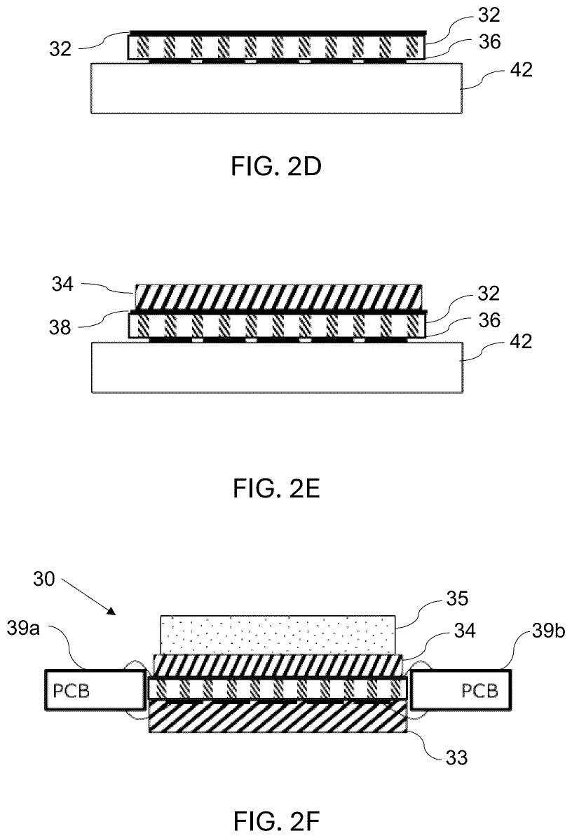

An example of a manufacturing process for architecture 30 shown in FIG. 1C is shown in FIG. 2A-2F. In FIG. 2A, an active, transducer layer 32 is adhered to a flat carrier layer 40. In FIG. 2B, a conductive layer 36 is deposited on transducer layer 32 and patterned to form electrodes. In FIG. 2C, transducer layer 32 is released from carrier layer and conductive layer 36 is adhered to a further carrier layer 42. The thickness of acoustically active layer may be reduced, if necessary, such that the thickness is substantially one quarter of one wavelength of a predefined center frequency. In FIG. 2D, a second conductive layer 38 is deposited on the opposite side of transducer layer 32, and patterned as a second set of electrodes. In FIG. 2E, a backing layer 34 is adhered against second conductive layer 38, such as a backing layer made from a dielectric material. In FIG. 2F, carrier layer 42 is removed, and architecture 30 may be formed with an additional backing layer 35 and a matching layer 33, and PCBs 39a and 39b wire bonded to conductive layers 36 and 38.

### Simulation Results:

A KLM Model was used to compare the performance of sapphire-backed quarter-wave transducers with half-wave-thickness transducers.

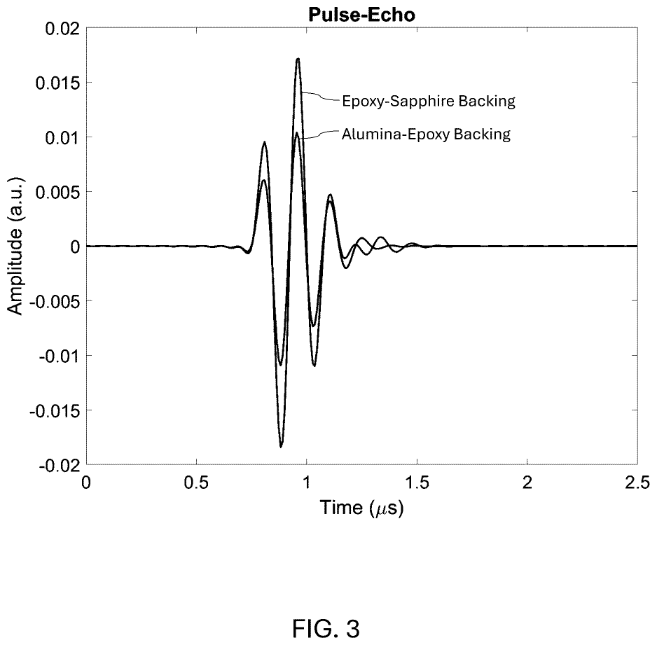

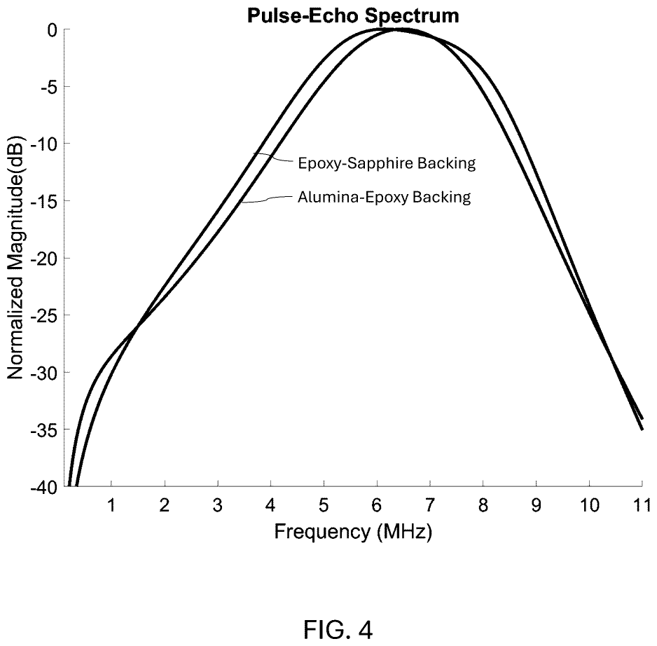

For the KLM modeling, the following parameters were used for a 1-3 composite active material with a speed of sound of 3900 m/s, electromechanical coefficient of 0.53, dielectric constant of 3450, and acoustic impedance of 16.5 MRayls. We chose the thickness of active material to be 270 and 135 micrometers for the conventional half-wavelength thick and quarter-wavelength-thick transducer, respectively. This would result in having a transducer with a center frequency of 6.5 MHz. For both transducers, we have considered one layer of quarter-wavelength-thick Parylene C as the matching layer. The pulse-echo response and the spectrum obtained from KLM modeling are shown in FIG. 3 and FIG. 4, respectively. The proposed transducer with epoxy-sapphire backing has shown a fractional bandwidth of 61% compared to 51% for the conventional half-wavelength-thick transducer with alumina-loaded epoxy as the backing. Also, from the simulations, the proposed transducer showed an increased pulse-echo signal amplitude from 21 mVpp to 36 mVpp for a 1Vpp excitation pulse.

Physical Implementation: FIGS. 5 and 6 are microscope images of fabricated quarter-thickness, sapphire-backed row-column arrays with an electrostrictive relaxor PMN-PT composite.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

1. An architecture for an edge-addressed ultrasound transducer, the architecture comprising:
an acoustically active layer having a thickness that is substantially one quarter wavelength of a predefined center frequency, the acoustically active layer having a first surface and a second surface opposite the first surface, the acoustically active layer being bias-voltage sensitive;
a backing layer adjacent to the first surface of the acoustically active layer, the backing layer having a thickness that is substantially one quarter of a wavelength of the predefined center frequency, the backing layer having an acoustic impedance that is greater than the acoustically active layer, the backing layer being in contact with a low acoustic impedance material, the backing layer comprising a plurality of first electrodes in a first electrode layer adjacent to the acoustically active layer;
a plurality of second electrodes in a second electrode layer adjacent to the second surface of the acoustically active layer;
wherein the plurality of first electrodes and the plurality of second electrodes define a plurality of acoustically active elements within the acoustically active layer, and wherein the plurality of first electrodes and the plurality of second electrodes are electrically coupled to electrical connections accessible at an outer perimeter of the transducer; and
a controller operable to apply one or more bias voltages to at least one of the first electrode layer and the second electrode layer.

2. The architecture of claim 1, wherein the acoustically active layer comprises an acoustically active material or a composite material.

3. The architecture of claim 1, further comprising one or more matching layers between the second surface of the acoustically active layer and a transmission medium, the one or more matching layers facilitating energy transduction between the acoustically active layer and the transmission medium.

4. The architecture of claim 1, further comprising a layer of adhesive between the backing layer and the acoustically active layer, the layer of adhesive having a thickness that is negligible relative to the wavelength of the predefined center frequency.

5. The architecture of claim 1, wherein the backing layer is at least partly transparent or translucent to electromagnetic waves within a predefined range of electromagnetic wavelengths.

6. The architecture of claim 1, wherein the backing layer comprises sapphire, diamond, a ceramic, or transparent aluminum.

7. The architecture of claim 1, wherein the acoustically active layer comprises a piezoelectric single crystal substrate, a piezoelectric ceramic, an electrostrictive relaxor material, PMN-PT, or a composite thereof.

8. The architecture of claim 1, wherein at least one of the first electrode layer and the second electrode layer comprises electrodes patterned as a row-column array, a synthetic phase alternating row-column array, a Costas array, or a sparse array.

9. The architecture of claim 1, wherein the first electrode layer and the second electrode layer each comprise a conductive material that is at least partially transparent or translucent to electromagnetic waves within a predefined range of electromagnetic wavelengths.

10. The architecture of claim 1, wherein the low acoustic impedance material has an acoustic impedance that is less than the acoustic impedance of the acoustically active layer.

11. The architecture of claim 1, wherein the backing layer comprises a dielectric material.

12. A method of manufacturing an edge-addressed ultrasound array, the method comprising the steps of:
adhering a second surface of an acoustically active layer to a carrier structure;
depositing a first conductive layer on a first surface of the acoustically active layer opposite the second surface, the first conductive layer being patterned to form a plurality of first electrodes;
releasing the acoustically active layer from the carrier layer, and adhering the first surface of the acoustically active layer to a carrier layer;
reducing a thickness of the acoustically active layer to a thickness that is substantially one quarter of one wavelength of a predefined center frequency;
depositing a second conductive layer on the acoustically active layer opposite the first conductive layer, the second conductive layer being patterned to form a plurality of second electrodes, wherein the plurality of first electrodes and the plurality of second electrodes define an array of acoustically active elements;
using an adhesive, adhering a backing layer adjacent to the second conductive layer, the backing layer being rigid and substantially flat, the backing layer having an acoustic impedance that is larger than the acoustically active layer, the backing layer having a thickness that is substantially one quarter of one wavelength of the predefined center frequency, and the adhesive having a thickness that is negligible relative to the thickness of the acoustically active layer;
connecting the plurality of first electrodes of the first conductive layer and the plurality of second electrodes of the second conductive layer to electrical interconnects along one or more edges of the array; and
forming one or more matching layers on an active aperture of the array, the one or more matching layers facilitating energy transduction between the acoustically active layer and the transmission medium.

13. The method of claim 12, wherein the acoustically active layer is made of acoustically active material or a composite material.

14. The method of claim 12, wherein the plurality of first and second electrodes are patterned using a laser micromachining system, a photolithography system, or a dicing saw.

15. The method of claim 12, wherein the electrical interconnects are formed using wire-bonding, laser micromachining of deposited conductors, soldering, or laser sintering.

16. The method of claim 12, wherein the backing layer comprises sapphire, diamond, a ceramic, transparent aluminum, or composite thereof.

17. The method of claim 12, wherein the acoustically active layer comprises a piezoelectric single crystal substrate, a piezoelectric ceramic, electrostrictive relaxor material, PMN-PT, or composite thereof.

18. The method of claim 12, wherein the plurality of first and second electrodes are patterned to form a row-column array, a synthetic phase alternating row-column array, a Costas array, a sparse array, or other edge-addressed array.

19. The method of claim 12, wherein the acoustically active layer comprises an electrostrictive relaxor material and external electronics are used to supply bias voltages that cause the electrostrictive relaxor to become effectively piezoelectric.

20. A method for imaging, the method comprising:
providing an architecture for an edge-addressed ultrasound transducer as described in claim 1;
delivering acoustic or electromagnetic energy to a target; and
causing the architecture to receive ultrasonic energy, the ultrasonic energy being transduced to electrical energy using the edge-addressed transducer.

21. The method of claim 20, wherein delivering acoustic or electromagnetic energy comprises using light from an optical source.
